(19) United States
(12) Patent Application Publication
(10) Pub. No.: US 2026/0051298 A1
(43) Pub. Date: Feb. 19, 2026

(54) DISPLAY DEVICE AND THRESHOLD VOLTAGE SENSING METHOD OF THE SAME

(71) Applicant: Seoul National University R&DB FOUNDATION, Seoul (KR)

(72) Inventors: Soo Yeon LEE, Seoul (KR); Kyeong Soo KANG, Seoul (KR)

(73) Assignee: Seoul National University R&DB FOUNDATION, Seoul (KR)

(21) Appl. No.: 19/103,618

(22) PCT Filed: Aug. 16, 2023
(86) PCT No.: PCT/KR2023/012116

§ 371 Date: Feb. 13, 2025

(30) Foreign Application Priority Data
Aug. 16, 2022 (KR) 10-2022-0101861
Aug. 16, 2023 (KR) 10-2023-0106752

(51) Int. Cl. G09G 3/3266; G09G 3/00; G09G 3/3291

(52) U.S. Cl. CPC G09G 3/3266; G09G 3/006; G09G 3/3291; G09G 2320/045; G09G 2330/12; G09G 2340/16

(57) ABSTRACT

The display device of the present invention comprises: a display panel including a plurality of pixel rows; a scan driver providing a scan signal and a sensing signal to each of the plurality of pixel rows; a data driver connected to the plurality of pixel rows through a plurality of data lines; a sensing circuit connected to the plurality of pixel rows through a plurality of sensing lines; and controlling the scan driver, the data driver, and the sensing circuit.

### TECHNICAL FIELD

The present invention relates to a display device, and more specifically, to a display device performing a sensing operation, and a method for sensing a threshold voltage of a driving transistor.

### BACKGROUND TECHNOLOGY OF THE INVENTION

In a display device such as an organic light-emitting display device, even if a plurality of pixels are manufactured by the same process, the driving transistors of the plurality of pixels have different driving characteristics (e.g., threshold voltages), and the plurality of pixels can emit light with different brightnesses. In addition, as the driving time of the display device accumulates, the plurality of pixels can deteriorate, and the driving characteristics of the driving transistors can deteriorate. In order to compensate for such brightness unevenness and deterioration of the display panel, the display device can perform a sensing operation that senses the driving characteristics of the driving transistors of the plurality of pixels.

However, in order to accurately sense the driving characteristics of the driving transistors of the plurality of pixels, sufficient sensing time (e.g., several tens of ms) is required to saturate the source voltages of the driving transistors. Accordingly, there is a problem that the sensing operation cannot be performed in real time while the display device displays an image.

### CONTENTS OF THE INVENTION

### Problems to be Solved

One purpose of the present invention is to provide an organic light-emitting display device capable of performing a sensing operation for sensing the driving characteristics of a driving transistor in real time.

Another purpose of the present invention is to provide a method for sensing driving characteristics in a device capable of performing a sensing operation for sensing the driving characteristics of a driving transistor in real time.

The technical objects to be achieved by the present invention are not limited to the above-mentioned matters, and other technical problems not mentioned can be considered by those skilled in the art from the embodiments of the present invention described below.

### Means for Solving the Problem

In order to achieve one object of the present invention, a display device according to one embodiment of the present invention includes a display panel including a plurality of pixel rows; a scan driver providing a scan signal and a sensing signal to each of the plurality of pixel rows; a data driver connected to the plurality of pixel rows through a plurality of data lines; a sensing circuit connected to the plurality of pixel rows through a plurality of sensing lines; and controllable the scan driver, the data driver, and the sensing circuit.

In addition, the display device includes a controller for selecting at least one pixel row among the plurality of pixel rows in a vertical blank period of each frame section, and the vertical blank period may include a sensing time during which the sensing circuit performs a sensing operation on the selected pixel row.

The sensing circuit measures a first drain voltage of a driving transistor of each pixel of the selected pixel row at a first point in time during the sensing time, and measures a second drain voltage of the driving transistor at a second point in time during the sensing time, and the controller can predict a current saturated drain voltage of the driving transistor based on the first drain voltage and the second drain voltage, and calculate a threshold voltage change amount of the driving transistor based on a difference between a previous saturated drain voltage and the current saturated drain voltage.

According to one embodiment, the threshold voltage variation of the driving transistor can be calculated by reflecting the current saturated drain voltage acquired by the current sensing operation from the previous drain-source voltage acquired by the previous sensing operation.

According to one embodiment, the pixel can include the driving transistor having a gate, a source receiving a first power voltage, and a drain; a first switching transistor having a gate receiving the scan signal, a drain connected to a corresponding one of the plurality of data lines, and a source connected to the gate of the driving transistor; a fourth switching transistor having a gate receiving the sensing signal, a drain connected to the drain of the driving transistor, and a source connected to a corresponding one of the plurality of sensing lines; a storage capacitor having a first electrode connected to the source of the driving transistor, and a second electrode connected to the drain of the driving transistor via the gate of the driving transistor and a second transistor; and a light-emitting element having an anode and a cathode electrode connected to the source of the driving transistor and the second power voltage.

According to one embodiment, the controller may be characterized by sequentially selecting the plurality of pixel rows on which the sensing operation is to be performed in a plurality of frame sections.

According to one embodiment, the controller may be characterized by randomly selecting the plurality of pixel rows on which the sensing operation is to be performed in a plurality of frame sections.

According to one embodiment, the source voltage of the driving transistor may be fixed to the first power voltage during the sensing time, and the drain voltage of the driving transistor may have the same value as the gate voltage.

According to one embodiment, the driving transistor may be characterized by having a gate node and a drain node connected when charging the sensing line.

According to one embodiment, the data driver may apply a sensing data voltage to the plurality of data lines during the sensing time, and the scan driver may apply the scan signal and the sensing signal to the selected pixel row during the sensing time.

In addition, the sensing circuit may be characterized by applying a reference voltage to the plurality of sensing lines before the sensing time, sampling the voltage of each of the plurality of sensing lines at the first point in time of the sensing time to measure the first drain voltage, and sampling the voltage of each of the plurality of sensing lines at the second point in time of the sensing time to measure the second drain voltage.

According to one embodiment, the vertical blanking period may be characterized by performing external compensation on one or more of the lines for each frame.

A threshold voltage sensing method in a display device comprising a plurality of pixel rows, according to another embodiment of the present invention, may include:
selecting at least one pixel row from among the plurality of pixel rows during a vertical blanking period of each frame interval;
measuring a first drain voltage of a driving transistor of each pixel in the selected pixel row at a first point in time during the sensing period within the vertical blanking period;
measuring a second drain voltage of the driving transistor at a second point in time during the sensing period;
predicting a current saturation source voltage of the driving transistor based on the first drain voltage and the second drain voltage; and
calculating a threshold voltage variation of the driving transistor based on the difference between a previous saturation drain voltage and the current saturation drain voltage.

According to one embodiment, the step of predicting the current saturated drain voltage of the driving transistor may include the step of calculating a gate voltage using the mathematical expression

$$“ {V}_{g} = {V}_{s} - \vert {V}_{tA} \vert = \frac{{( {V}_{g} ( t ) - {V}_{g} ( 0 ) )}^{2} Δ t}{( {V}_{g} ( t ) - {V}_{g} ( 0 ) ) Δ t - [ {V}_{g} ( t + Δ t ) - {V}_{g} ( t ) ] t} + {V}_{g} ( 0 ) ” .$$

According to one embodiment, the step of calculating the threshold voltage variation of the driving transistor may include the step of calculating the threshold voltage variation of the driving transistor by reflecting the current saturated drain voltage obtained by the current sensing operation from the previous saturated drain voltage obtained by the previous sensing operation.

According to one embodiment, the step of selecting the pixel rows may be characterized by including the step of sequentially selecting the plurality of pixel rows on which the sensing operation is to be performed in a plurality of frame sections.

According to one embodiment, the step of selecting the pixel row may be characterized by including the step of randomly selecting the pixel row on which the sensing operation is to be performed among the plurality of pixel rows in each frame section.

### Effect of the Invention

In a display device and a threshold voltage sensing method of the display device according to embodiments of the present invention, first and second drain voltages of a driving transistor of each pixel of a selected pixel row are measured at first and second points in time of a sensing time within a vertical blank period, a current saturated drain voltage of the driving transistor is predicted based on the first and second drain voltages, a threshold voltage variation of the driving transistor is calculated based on a difference between a previous saturated drain voltage and the current saturated drain voltage, and a threshold voltage of the driving transistor can be determined based on the threshold voltage variation.

Accordingly, since the current saturated drain voltage of the driving transistor after saturation is predicted using the first and second drain voltages of the driving transistor before saturation, a sensing operation for sensing the threshold voltage of the driving transistor can be performed in real time while the display device displays an image, and can also be performed accurately and efficiently.

However, the effects of the present invention are not limited to the above-mentioned effects, and may be variously expanded within a scope that does not depart from the spirit and scope of the present invention.

### BRIEF DESCRIPTION OF THE DRAWINGS

FIG. 1 is a block diagram showing a display device according to embodiments of the present invention.

FIG. 2 is a circuit diagram showing a technology developed for a display device using an n-type TFT circuit and a threshold voltage sensing method.

FIG. 3 is a graph showing a change in a VSL value over time in the circuit diagram shown in FIG. 3.

FIG. 4 is a circuit diagram showing a technology developed for a display device using a p-type TFT circuit and a threshold voltage sensing method according to an embodiment of the present invention.

FIG. 5 is a graph showing a change in a voltage (VSL) value of a sensing line over time in the circuit diagram shown in FIG. 5 according to an embodiment of the present invention.

FIG. 6 is a timing diagram for explaining an example of an operation in a vertical blank section of a display device according to embodiments of the present invention.

FIG. 7 is a flowchart showing a threshold voltage sensing method in a p-type TFT circuit according to an embodiment of the present invention.

FIGS. 8 to 11 are drawings for explaining an example of a mathematical formula for a process of deriving an equation for predicting a saturated gate voltage in a threshold voltage sensing method according to embodiments of the invention.

FIG. 12 is a block diagram showing an electronic device including a display device according to embodiments of the present invention.

### SPECIFIC DETAILS FOR CARRYING OUT THE INVENTION

Hereinafter, embodiments of the present invention will be described in detail with reference to the attached drawings. When adding reference numerals to components of each drawing, it should be noted that the same numerals are used for the same components as much as possible even if they are shown in different drawings. Furthermore, in describing the embodiments of the present invention, detailed descriptions of well-known configurations or functions may be omitted if it is determined that such descriptions would hinder the understanding of the embodiments of the present invention.

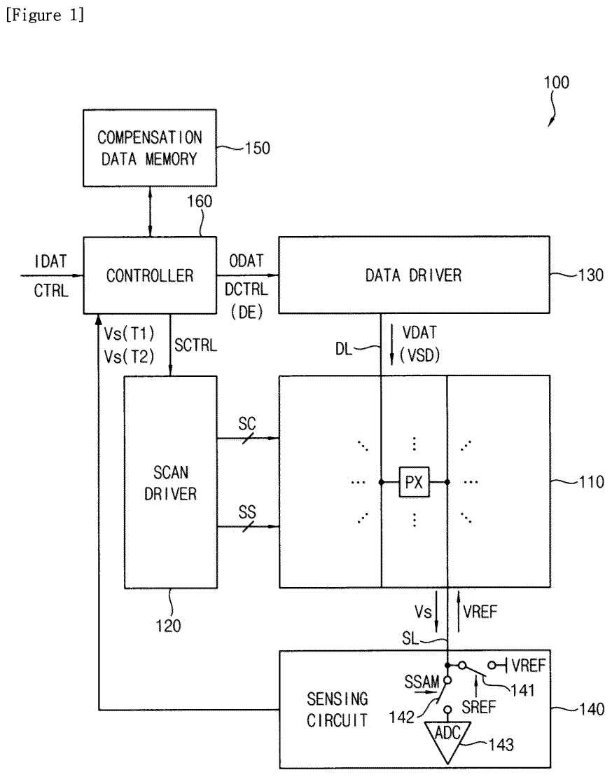

FIG. 1 is a block diagram showing a display device according to embodiments of the present invention.

Referring to FIG. 1, a display device (100) according to embodiments of the present invention may include a display panel (110) including a plurality of pixel rows, a scan driver (120) providing a scan signal (SC) and a sensing signal (SS) to each of the plurality of pixel rows, a data driver (130) connected to the plurality of pixel rows through a plurality of data lines (DL), a sensing circuit (140) connected to the plurality of pixel rows through a plurality of sensing lines (SL), and a controller (160) controlling the scan driver (120), the data driver (130), and the sensing circuit (140). In addition, in one embodiment, the display device (100) may further include a compensation data memory (150) storing compensation data for compensating a threshold voltage of a driving transistor of each pixel (PX).

The display panel (110) may include a plurality of data lines (DL), a plurality of sensing lines (SL), and a plurality of pixel rows connected to the plurality of data lines (DL) and the plurality of sensing lines (SL). Here, each pixel row may be pixels (PX) of the same row, which receive the same scan signal (SC) and the same sensing signal (SS). In addition, the display panel (110) may further include a plurality of scan signal lines each connected to the plurality of pixel rows, and a plurality of sensing signal lines each connected to the plurality of pixel rows. In one embodiment, each pixel (PX) includes a light-emitting element, and the display panel (110) may be a light-emitting display panel. For example, the display panel (110) may be an organic light emitting diode (OLED) display panel, a quantum dot (QD) display panel, or the like, but is not limited thereto.

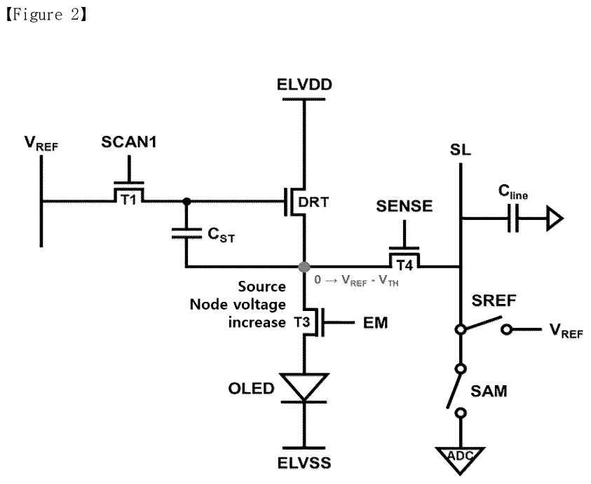

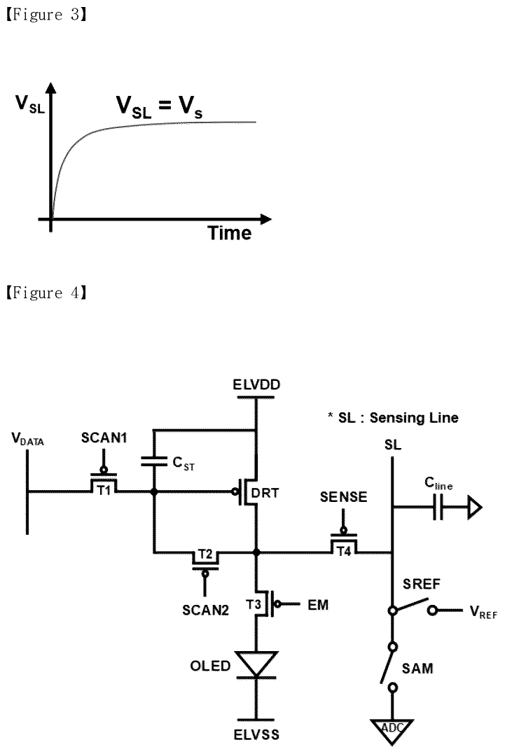

FIG. 2 is a circuit diagram of a technology developed for a display device and a threshold voltage sensing method using an n-type TFT circuit, and FIG. 3 is a graph showing changes in VSL values over time in the circuit diagram illustrated in FIG. 3.

A threshold voltage sensing method in a display device can be performed using, for example, an n-type TFT as illustrated in FIG. 2.

At this time, each pixel (PX) may include a driving transistor (DRT), a first switching transistor (T1), a fourth switching transistor (T4), a storage capacitor (CST), and an organic light-emitting device (OLED).

In the above embodiment using an n-type TFT, the storage capacitor (CST) may have a first electrode connected to a gate of the driving transistor, and a second electrode connected to a source of the driving transistor.

In the above embodiment using an n-type TFT, the storage capacitor (CST) may have a first electrode connected to a gate of the driving transistor, and a second electrode connected to a source of the driving transistor.

At this time, referring to FIG. 3, the drain voltage (Vd) of the driving transistor is fixed to VDD, the gate voltage (Vg) is fixed to VREF, and the source voltage (VS) increases from 0 to VREF−VTH.

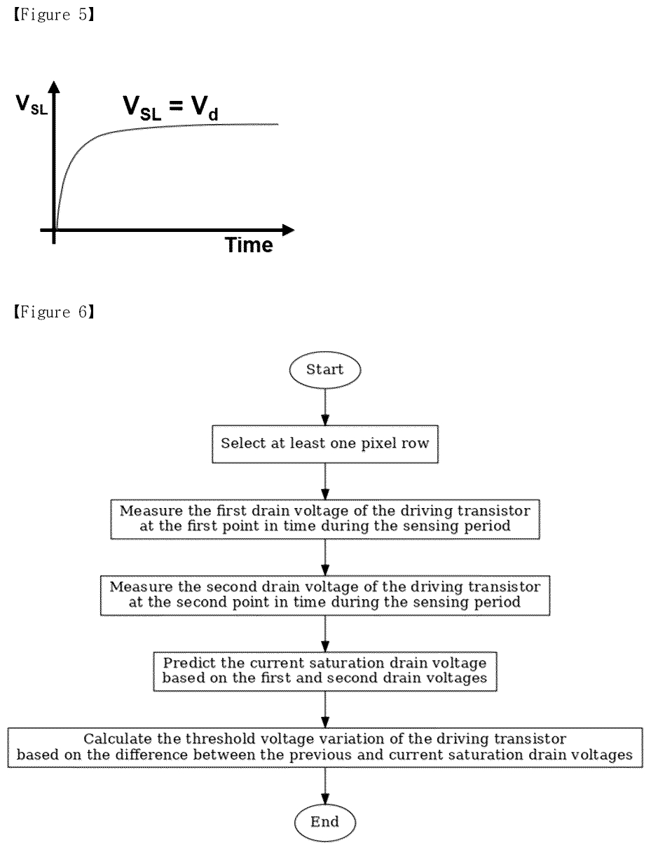

FIG. 4 is a circuit diagram of a technology developed for a display device and a threshold voltage sensing method using a p-type TFT circuit according to one embodiment of the present invention, and FIG. 5 is a graph showing a change in a VSL value over time in the circuit diagram according to one embodiment of the present invention illustrated in FIG. 5.

The threshold voltage sensing method in a display device can be performed using a p-type TFT as illustrated in FIG. 4 by changing the structure of the circuit diagram of FIG. 2, for example. The inventors of the present invention have derived a new method capable of performing a threshold voltage sensing operation of a driving transistor using a p-type TFT, taking inspiration from the structure of a circuit designed using the above-described n-type TFT.

In one embodiment using a p-type TFT, a circuit can be used in which the location of the storage capacitor (CST) is changed and a second switching transistor is added compared to the circuit diagram of FIG. 2 (see FIG. 4).

When using a circuit including a p-type TFT proposed in one embodiment of the present invention, when the sensing line voltage increases and becomes saturated, the circuit can be driven by checking the difference between the sensing line voltage and the gate voltage and performing external compensation.

In the case of existing circuits, a time gap of several tens of milliseconds occurs due to the cap of the sensing line, so one of the purposes of the present invention is to propose a method to do this in real time.

In order to achieve one object of the present invention, a display device according to one embodiment of the present invention may control a display panel including a plurality of pixel rows; a scan driver providing a scan signal and a sensing signal to each of the plurality of pixel rows; a data driver connected to the plurality of pixel rows through a plurality of data lines; a sensing circuit connected to the plurality of pixel rows through a plurality of sensing lines; and the scan driver, the data driver, and the sensing circuit.

Additionally, the device may include a controller that selects at least one pixel row among the plurality of pixel rows in a vertical blank period of each frame section, wherein the vertical blank period may include a sensing time during which the sensing circuit performs a sensing operation for the selected pixel row.

The sensing circuit measures a first drain voltage of a driving transistor of each pixel of the selected pixel row at a first point in time during the sensing time, and measures a second drain voltage of the driving transistor at a second point in time during the sensing time, and the controller can predict a current saturated drain voltage of the driving transistor based on the first drain voltage and the second drain voltage, and calculate a threshold voltage change amount of the driving transistor based on a difference between a previous saturated drain voltage and the current saturated drain voltage.

At this time, referring to the circuit diagram illustrated in FIG. 4, each pixel may include a driving transistor (DRT), a first switching transistor (T1), a second switching transistor (T2), a fourth switching transistor (T4), a storage capacitor (CST), and an organic light-emitting element (OLED).

In one embodiment, the storage capacitor (CST) may have a first electrode connected to a source of the driving transistor and a second electrode connected to a drain of the driving transistor via a gate of the driving transistor and a second transistor.

A first switching transistor can connect a data line to the second electrode of a storage capacitor (CST) in response to a first scan signal (SCAN1). The first switching transistor can transfer a data voltage (VDATA) (or a sensing data voltage) of the data line to the second electrode of the storage capacitor (CST) in response to the first scan signal. In one embodiment, the first switching transistor can have a gate receiving a scan signal, a drain connected to the data line, and a source connected to the second electrode of the storage capacitor and a gate of a driving transistor.

The fourth switching transistor (T4) can connect the sensing line (SL) to the second switching transistor connected to the second line of the storage capacitor and the drain of the driving transistor in response to the sensing signal (SENSE). In one embodiment, the fourth switching transistor can have a gate that receives the sensing signal, a drain and a source connected to the drain of the driving transistor and the sensing line (SL). Meanwhile, the sensing line (SL) can be connected to the line capacitor (CL). In one embodiment, the line capacitor (CL) can be a parasitic capacitor of the sensing line (SL), but is not limited thereto.

At this time, referring to FIG. 3, in the circuit diagram of FIG. 4 according to one embodiment, the source voltage (Vs) of the driving transistor is fixed to VDD, and the drain voltage (Vd) and the gate voltage (Vg) increase from 0 to VDD−VTH.

The driving transistor can generate a driving current based on the data voltage (VDATA) stored in the storage capacitor. In one embodiment, the driving transistor (TDR) can have a gate connected to the second electrode of the storage capacitor (CST), a source connected to the first electrode of the storage capacitor (CST) and a first power supply voltage (ELVDD) (e.g., a high power supply voltage), and a drain connected to the fourth switching transistor (T4) and the second switching transistor.

The organic light emitting device (OLED) illustrated in FIG. 4 can emit light in response to the driving current generated by the driving transistor. According to an embodiment, the organic light emitting device of FIG. 4 may be, but is not limited to, an organic light emitting diode (OLED) as well as a quantum dot (QD) diode. In one embodiment, the organic light emitting device may have an anode and a cathode electrode connected between the drain of the driving transistor and a second power supply voltage (ELVSS) (e.g., a low power supply voltage).

The pixels of the display device (100) according to embodiments of the present invention are illustrated as an example using an n-type TFT in FIG. 2 and an example using a p-type TFT in FIG. 4, but are not limited to specific examples.

Below, an example of a sensing operation performed in a display device according to embodiments of the present invention is described with reference to FIG. 6.

FIG. 6 is a timing diagram for explaining an example of operation in a vertical blank section of a display device according to embodiments of the present invention.

The scan driver of the display device may generate scan signals and sensing signals based on a scan control signal received from a controller, and sequentially provide the scan signals and sensing signals to a plurality of pixels in a pixel row unit during an active period of each frame period. In one embodiment, the scan control signal may include a start signal and a clock signal, but is not limited thereto. In one embodiment, the scan driver may be integrated or formed in a periphery of the display panel. In another embodiment, the scan driver may be implemented with one or more integrated circuits.

The data driver may generate data voltages based on output image data and a data control signal received from the controller, and provide the data voltages to a plurality of pixels in an active period of each frame period. In one embodiment, the data driver may provide sensing data voltages to pixels of a selected pixel row in a blank period of each frame period. In one embodiment, the data control signal may include a data enable signal that periodically transitions to indicate transmission timing of output image data in the active period and has a low level in the blank period. In addition, in one embodiment, the data control signal may further include, but is not limited to, a horizontal start signal, a load signal, etc. In one embodiment, the data driver may be implemented with one or more integrated circuits. In another embodiment, the data driver and the controller may be implemented with a single integrated circuit, and such an integrated circuit may be called a timing controller embedded data driver (TED).

The sensing circuit can provide a reference voltage to a pixel row where a sensing operation is performed through a plurality of sensing lines, and can receive voltages of driving transistors of pixels of the pixel row through the plurality of sensing lines. In one embodiment, the sensing circuit can include one ADC for each sensing line. In another embodiment, the sensing circuit can include one ADC for each of a plurality of sensing lines, for example, four, eight, or sixteen sensing lines, and the ADC can perform analog-to-digital conversion for source voltages of the plurality of sensing lines in a time-division manner.

In one embodiment, the sensing circuit may be implemented as a separate integrated circuit from the integrated circuit of the data driver. In another embodiment, the sensing circuit may be included in the data driver or may be included in the controller.

Meanwhile, the compensation data memory can store compensation data corresponding to the threshold voltage of the driving transistor of each pixel. The compensation data can be used to apply a data voltage in which the threshold voltage of the driving transistor of the pixel is compensated for (e.g., added to) to each pixel. In one embodiment, the compensation data memory can be implemented as at least one memory device located externally and/or internally of the controller, but is not limited thereto.

According to one embodiment, the threshold voltage variation of the driving transistor can be calculated by reflecting the current saturated drain voltage obtained by the current sensing operation from the previous drain-source voltage obtained by the previous sensing operation.

According to one embodiment, the pixel may include: a driving transistor having a gate, a source receiving a first power voltage, and a drain; a first switching transistor having a gate receiving the scan signal, a drain connected to a corresponding one of the plurality of data lines, and a source connected to the gate of the driving transistor; a fourth switching transistor having a gate receiving the sensing signal, a drain connected to the drain of the driving transistor, and a source connected to a corresponding one of the plurality of sensing lines; a storage capacitor having a first electrode connected to the source of the driving transistor, and a second electrode connected to the drain of the driving transistor via the gate of the driving transistor and a second transistor; and a light-emitting element having an anode and a cathode electrode connected to the source of the driving transistor and the second power voltage.

In one embodiment, the controller may be characterized by sequentially selecting the plurality of pixel rows on which the sensing operation is to be performed in a plurality of frame intervals.

In one embodiment, the controller may be characterized by randomly selecting the plurality of pixel rows on which the sensing operation is to be performed in a plurality of frame intervals.

According to one embodiment, the source voltage of the driving transistor is fixed to the first power supply voltage during the sensing time, and the drain voltage of the driving transistor can have the same value as the gate voltage.

According to one embodiment, when charging the sensing line, the driving transistor may be characterized in that the gate node and the drain node are connected. According to one embodiment, the data driver may apply a sensing data voltage to the plurality of data lines during the sensing time, and the scan driver may apply the scan signal and the sensing signal to the selected pixel row during the sensing time.

In addition, the sensing circuit may be characterized by applying a reference voltage to the plurality of sensing lines before the sensing time, sampling the voltage of each of the plurality of sensing lines at the first point in time of the sensing time to measure the first drain voltage, and sampling the voltage of each of the plurality of sensing lines at the second point in time of the sensing time to measure the second drain voltage.

In one embodiment, the vertical blanking section may be characterized by performing external compensation on one or more of the lines for each frame.

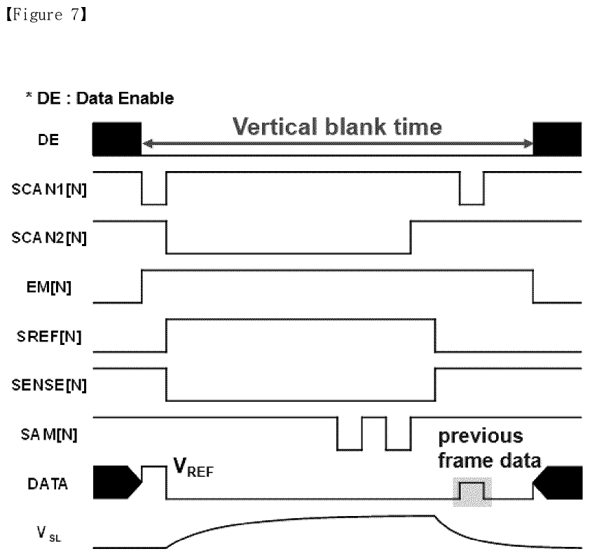

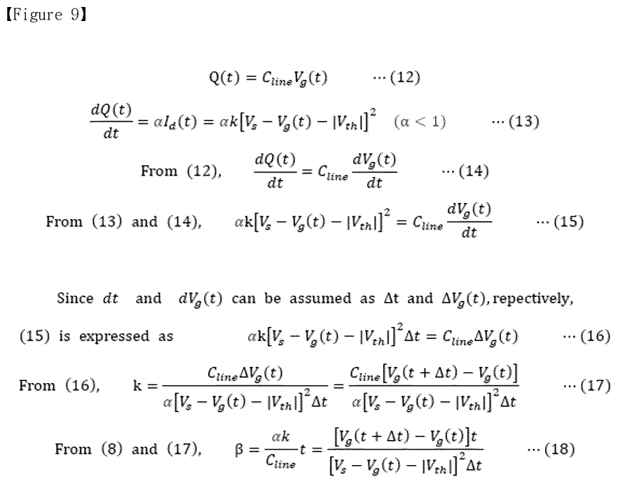

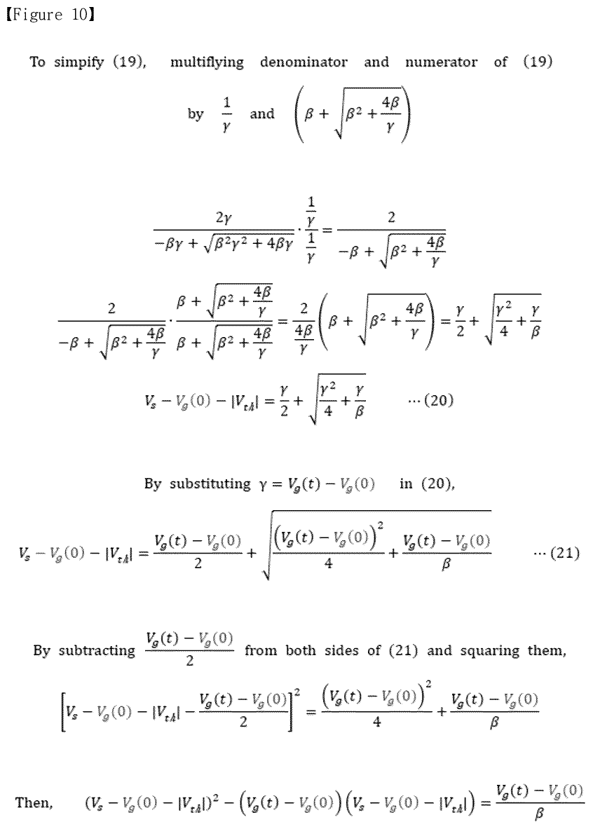

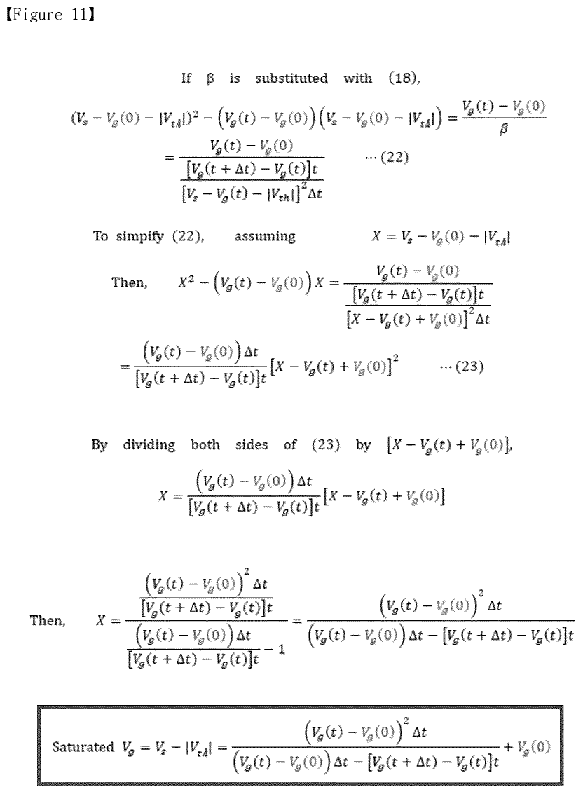

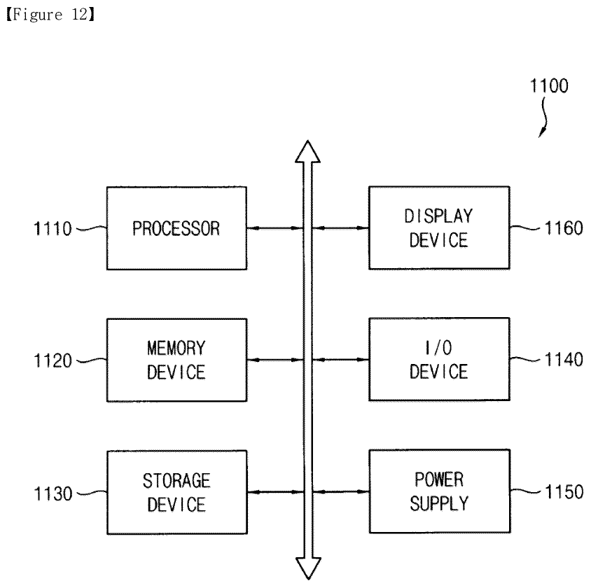

Hereinafter, a threshold voltage sensing method of a display device according to one embodiment of the present invention will be described in detail with reference to FIGS. 7 and 8 to 11.

FIG. 7 is a flowchart showing a threshold voltage sensing method in a p-type TFT circuit according to one embodiment of the present invention.

External compensation can be performed by selecting lines in a random or sequential manner for each vertical blank section within each frame according to the flowchart shown in FIG. 7.

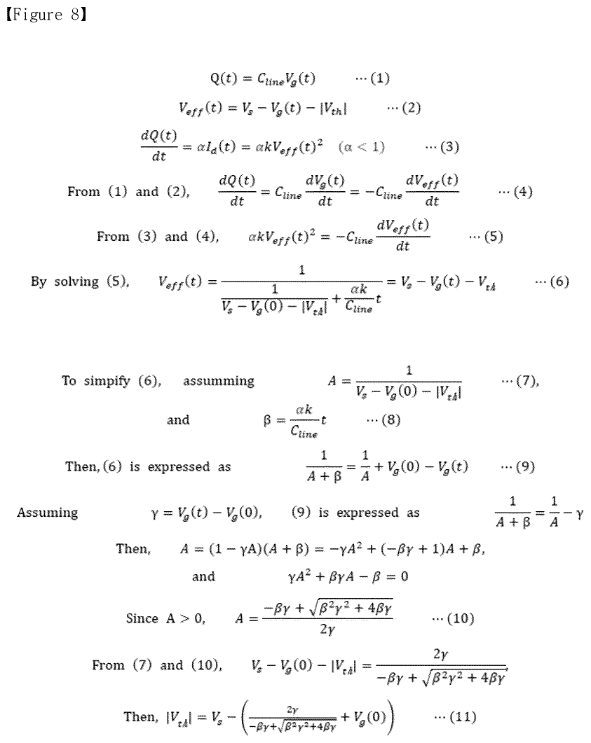

FIGS. 8 to 11 are diagrams for explaining an example of a mathematical formula for a process of deriving an equation for predicting a saturated gate voltage in a threshold voltage sensing method according to embodiments of the invention.

When charging the sensing line presented in the embodiment of the present invention, the p-type TFT can utilize a diode-connection structure. At this time, since the gate node and the drain node are connected to form a state where Vg(t)=Vd(t), Vd(t) can be used in the formula instead of Vg(t). That is, Vd(t)=VSL(t) is revealed in the mathematical formulas of FIGS. 8 to 11.

Regarding external compensation circuits, there have been cases where formulas have been proposed in the past, but the existing formulas have assumed the k term for mobility as a constant. However, in reality, mobility is not a value that can be treated as a constant, and one of the characteristic elements of the above-described mathematical formula is that the k term is introduced as a value for the gate voltage (Vg) and the source voltage (Vs), which may be a difference from the existing methods.

According to another embodiment of the present invention, a threshold voltage sensing method of a display device includes a threshold voltage sensing method in a display device including a plurality of pixel rows, the method including the steps of: selecting at least one pixel row among the plurality of pixel rows in a vertical blank period of each frame period (S110); measuring a first drain voltage of a driving transistor of each pixel of the selected pixel row at a first point in time during a sensing time within the vertical blank period (S120); measuring a second drain voltage of the driving transistor at a second point in time during the sensing time (S130); predicting a current saturated source voltage of the driving transistor based on the first drain voltage and the second drain voltage (S140); and calculating a threshold voltage variation of the driving transistor based on a difference between a previous saturated drain voltage and the current saturated drain voltage (S150).

According to one embodiment, the step of predicting the current saturated drain voltage of the driving transistor may include the step of calculating a gate voltage using the mathematical expression

$$“ {V}_{g} = {V}_{s} - \vert {V}_{tA} \vert = \frac{{( {V}_{g} ( t ) - {V}_{g} ( 0 ) )}^{2} Δ t}{( {V}_{g} ( t ) - {V}_{g} ( 0 ) ) Δ t - [ {V}_{g} ( t + Δ t ) - {V}_{g} ( t ) ] t} + {V}_{g} ( 0 ) ” .$$

According to one embodiment, the step of calculating the threshold voltage variation of the driving transistor may include the step of calculating the threshold voltage variation of the driving transistor by reflecting the current saturated drain voltage obtained by the current sensing operation from the previous saturated drain voltage obtained by the previous sensing operation.

According to one embodiment, the step of selecting the pixel row may be characterized by including a step of sequentially selecting the plurality of pixel rows on which the sensing operation is to be performed in a plurality of frame sections.

According to one embodiment, the step of selecting the pixel row may be characterized by including a step of randomly selecting the pixel row on which the sensing operation is to be performed among the plurality of pixel rows in each frame section.

FIG. 12 is a block diagram showing an electronic device including a display device according to embodiments of the present invention. The processor (1110) may perform specific calculations or tasks. According to an embodiment, the processor (1110) may be a microprocessor, a central processing unit (CPU), etc. The processor (1110) may be connected to other components via an address bus, a control bus, a data bus, etc. According to an embodiment, the processor (1110) may also be connected to an expansion bus such as a Peripheral Component Interconnect (PCI) bus.

The memory device (1120) can store data required for the operation of the electronic device (1100). For example, the memory device (1120) can include nonvolatile memory devices such as EPROM (Erasable Programmable Read-Only Memory), EEPROM (Electrically Erasable Programmable Read-Only Memory), flash memory, PRAM (Phase Change Random Access Memory), RRAM (Resistance Random Access Memory), NFGM (Nano Floating Gate Memory), PoRAM (Polymer Random Access Memory), MRAM (Magnetic Random Access Memory), FRAM (Ferroelectric Random Access Memory), and/or volatile memory devices such as DRAM (Dynamic Random Access Memory), SRAM (Static Random Access Memory), and mobile DRAM.

The storage device (1130) may include a solid state drive (SSD), a hard disk drive (HDD), a CD-ROM, etc. The input/output device (1140) may include an input means such as a keyboard, a keypad, a touchpad, a touchscreen, a mouse, etc., and an output means such as a speaker, a printer, etc. The power supply (1150) may supply power required for the operation of the electronic device (1100). The display device (1160) may be connected to other components via the buses or other communication links.

In the display device (1160), first and second drain voltages of a driving transistor of each pixel of a selected pixel row are measured at first and second points in time of a sensing time within a vertical blank period, a current saturated drain voltage of the driving transistor is predicted based on the first and second source voltages, a threshold voltage variation of the driving transistor is calculated based on a difference between a previous saturated drain voltage and the current saturated drain voltage, and a threshold voltage of the driving transistor can be determined based on the threshold voltage variation.

Accordingly, since the current saturation source voltage of the driving transistor after saturation is predicted using the first and second drain voltages of the driving transistor before saturation, the sensing operation for sensing the threshold voltage of the driving transistor can be performed in real time while the display device (1160) displays an image, and can also be performed accurately and efficiently.

According to an embodiment, the electronic device (1100) may be any electronic device including a display device (1160), such as a television (TV), a digital television (DTV), a 3D TV, a cellular phone, a smart phone, a tablet computer, a virtual reality (VR) device, a personal computer (PC), a home appliance, a laptop computer, a personal digital assistant (PDA), a portable multimedia player (PMP), a digital camera, a music player, a portable game console, a navigation system, etc.

The above description is merely an illustrative description of the technical idea of the present invention, and those skilled in the art will appreciate that various modifications and variations may be made without departing from the essential characteristics of the present invention. Accordingly, the embodiments disclosed in the present invention are not intended to limit the technical idea of the present invention but to explain it, and the scope of the technical idea of the present invention is not limited by these embodiments. The protection scope of the present invention should be interpreted by the following claims, and all technical ideas within a scope equivalent thereto should be interpreted as being included in the scope of the rights of the present invention.

1. A display device comprising:
a display panel including a plurality of pixel rows;
a scan driver configured to provide a scan signal and a sensing signal to each of the plurality of pixel rows;
a data driver connected to the plurality of pixel rows through a plurality of data lines;
a sensing circuit connected to the plurality of pixel rows via a plurality of sensing lines; and
a controller configured to control the scan driver, the data driver, and the sensing circuit, and to select at least one pixel row from among the plurality of pixel rows during a vertical blanking period of each frame interval,
wherein the vertical blanking period includes a sensing period during which the sensing circuit performs a sensing operation on the selected pixel row,
wherein the sensing circuit is configured to measure a first drain voltage of a driving transistor of each pixel in the selected pixel row at a first point in time during the sensing period, and to measure a second drain voltage of the driving transistor at a second point in time during the sensing period, and
wherein the controller is configured to predict a current saturation drain voltage of the driving transistor based on the first drain voltage and the second drain voltage, and to calculate a threshold voltage variation of the driving transistor based on the difference between a previous saturation drain voltage and the current saturation drain voltage.

2. The display device according to claim 1,
wherein the threshold voltage variation of the driving transistor is calculated by reflecting the current saturation drain voltage obtained through the current sensing operation from the previous drain-source voltage obtained through the previous sensing operation.

3. The display device according to claim 1,
wherein each pixel comprises:
the driving transistor having a gate, a source receiving a first power voltage, and a drain;
a first switching transistor having a gate configured to receive the scan signal, a drain connected to a corresponding one of the plurality of data lines, and a source connected to the gate of the driving transistor;
a fourth switching transistor having a gate configured to receive the sensing signal, a drain connected to the drain of the driving transistor, and a source connected to a corresponding one of the plurality of sensing lines;
a storage capacitor having a first electrode connected to the source of the driving transistor, and a second electrode connected to the drain of the driving transistor through a second transistor and to the gate of the driving transistor; and
a light emitting element having an anode and a cathode connected between the source of the driving transistor and a second power voltage.

4. The display device according to claim 1,
wherein the controller is configured to sequentially select the plurality of pixel rows in which the sensing operation is to be performed across a plurality of frame intervals.

5. The display device according to claim 1,
wherein the controller is configured to randomly select the plurality of pixel rows in which the sensing operation is to be performed across a plurality of frame intervals.

6. The display device according to claim 1,
wherein the source voltage of the driving transistor is fixed to a first power voltage during the sensing period, and
the drain voltage of the driving transistor is the same as the gate voltage.

7. The display device according to claim 1,
wherein the driving transistor has its gate node and drain node connected when charging the sensing line.

8. The display device according to claim 1,
wherein the data driver is configured to apply a sensing data voltage to the plurality of data lines during the sensing period,
the scan driver is configured to apply the scan signal and the sensing signal to the selected pixel row during the sensing period, and
the sensing circuit is configured to apply a reference voltage to the plurality of sensing lines before the sensing period, to sample the voltage of each of the plurality of sensing lines at a first point in time during the sensing period to measure the first drain voltage, and to sample the voltage of each of the plurality of sensing lines at a second point in time during the sensing period to measure the second drain voltage.

9. The display device according to claim 1,
wherein the vertical blanking period is configured to perform external compensation for one or more of the lines in each frame.

10. A threshold voltage sensing method in a display device comprising a plurality of pixel rows, the method comprising:
selecting at least one pixel row from among the plurality of pixel rows during
a vertical blanking period of each frame interval;
measuring a first drain voltage of a driving transistor of each pixel in the selected pixel row at a first point in time during the sensing period within the vertical blanking period;
measuring a second drain voltage of the driving transistor at a second point in time during the sensing period;
predicting a current saturation source voltage of the driving transistor based on the first drain voltage and the second drain voltage; and
calculating a threshold voltage variation of the driving transistor based on the difference between a previous saturation drain voltage and the current saturation drain voltage.

11. The threshold voltage sensing method of a display device according to claim 10,
wherein the step of predicting the current saturation drain voltage of the driving transistor includes:
calculating a gate voltage using the mathematical expression
$$“ {V}_{g} = {V}_{s} - \vert {V}_{tA} \vert = \frac{{( {V}_{g} ( t ) - {V}_{g} ( 0 ) )}^{2} Δ t}{( {V}_{g} ( t ) - {V}_{g} ( 0 ) ) Δ t - [ {V}_{g} ( t + Δ t ) - {V}_{g} ( t ) ] t} + {V}_{g} ( 0 ) ” .$$

12. The threshold voltage sensing method of a display device according to claim 10,
wherein the step of calculating the threshold voltage variation of the driving transistor includes:
calculating the threshold voltage variation of the driving transistor by reflecting the current saturation drain voltage obtained through the current sensing operation from the previous saturation drain voltage obtained through the previous sensing operation.

13. The threshold voltage sensing method of a display device according to claim 10,
wherein the step of selecting the pixel row includes:
sequentially selecting the plurality of pixel rows in which the sensing operation is to be performed across a plurality of frame intervals.

14. The threshold voltage sensing method of a display device according to claim 10,
wherein the step of selecting the pixel row includes:
randomly selecting the pixel row in which the sensing operation is to be performed from among the plurality of pixel rows in each frame interval.
